(19) United States
(12) Patent Application Publication
(10) Pub. No.: US 2021/0319772 A1
(43) Pub. Date: Oct. 14, 2021

(54) Lo-Hat Drum Pedal Assembly

(71) Applicant: Jeffrey C. Landers, Crestline, OH (US)

(72) Inventor: Jeffrey C. Landers, Crestline, OH (US)

(21) Appl. No.: 17/229,634

(22) Filed: Apr. 13, 2021

Related U.S. Application Data
(60) Provisional application No. 63/009,320, filed on Apr. 13, 2020.

(51) Int. Cl. G10D 13/11; G10D 13/065

(52) U.S. Cl. CPC G10D 13/11; G10D 13/065

(57) ABSTRACT

A lo-hat drum pedal assembly is an apparatus that enables the user to modify a hi-hat stand to be used in a lo-hat configuration. The apparatus includes an extension arm, a height adjustment arm, a linkage arm, a suspension arm, a pedal attachment point, a strut attachment point, and a connector attachment point. The extension arm connects the stock stand pedal to the height adjustment arm. The height adjustment arm connects the extension arm to the linkage arm. The suspension arm enables the linkage arm to be hung from a base strut in a seesaw-like manner. The pedal attachment point is the location where the extension arm is connected to the stock stand pedal. The strut attachment point is the location where the suspension arm is connected to the stock base strut. The connector attachment point is the location where the linkage arm is connected to the stock cymbal rod.

The current application claims a priority to the U.S. provisional patent application Ser. No. 63/009,320 filed on Apr. 13, 2020.

### FIELD OF THE INVENTION

The present invention generally relates to musical instruments and drum accessories. More specifically, the present invention provides a lo-hat drum pedal assembly which enables a different method of playing musical instruments such as the cymbals.

### BACKGROUND OF THE INVENTION

In general, the majority of the currently used stands for percussion instruments such as the cymbals are hi-hat stands. Hi-hat stands are designed to keep cymbals in an open configuration while being played. When the stand pedal is pressed down, the cymbals are moved to a closed configuration by moving the top cymbal down. The player can control the movement of the top cymbal by changing the pressure applied on the stand pedal. Thus, the hi-hat stand gives users a variety of ways to playing the cymbals. However, some players may be inclined to play the cymbals in a different way. Some players may prefer a lo-hat configuration instead of a hi-hat configuration when playing the cymbals. In the lo-hat configuration, the cymbals are kept in a closed configuration while being played. When the stand pedal is pressed down, the cymbals are moved to the open configuration by moving the top cymbal up. Unfortunately, the unpopularity of lo-hat configurations has left players with few options for lo-hat stands. Lo-hat players must either order a custom stand or modify their hi-hat stands themselves. Therefore, an objective of the present invention is to provide a lo-hat drum pedal assembly which enables the user to modify a standard hi-hat stand to be operated as a lo-hat stand.

### SUMMARY OF THE INVENTION

The present invention provides a lo-hat drum pedal assembly that enables users to modify a hi-hat stand to be played as a lo-hat stand. The lo-hat drum pedal assembly enables users to play percussion instruments such as cymbals in a lo-hat configuration instead of a hi-hat configuration. The present invention can be installed in the base of the stand so that the stand pedal can be connected to the cymbal rod in a lo-hat configuration. Further, the present invention includes height adjustment means that facilitate the adjustment of the space between the pedal and the cymbal rod. The present invention can be supported by the existing structure of the stand base so that no additional tools or accessories are needed. Furthermore, the present invention is equipped with vibration dampening means to prevent the transmission of sound/vibrations throughout the structure. Additional features and benefits of the present invention are further discussed in the sections below.

### BRIEF DESCRIPTION OF THE DRAWINGS

FIG. 1 is a side view showing the present invention installed on a cymbal stand, wherein the cymbals are in a closed configuration.

FIG. 2 is a side view showing the present invention installed on the cymbal stand, wherein the cymbals are in an open configuration.

FIG. 3 is a magnified view taken about circle 3 in FIG. 2.

FIG. 4 is a bottom perspective view showing the present invention installed on the cymbal stand.

FIG. 5 is a magnified view taken about circle 5 in FIG. 4.

FIG. 6 is an exploded side view showing the extension arm, the height adjustment arm, the linkage arm, and the suspension arm of the present invention.

FIG. 7 is a top perspective view showing the extension arm, the height adjustment arm, the linkage arm, and the suspension arm assembled in a first configuration.

FIG. 8 is a top perspective view showing the extension arm, the height adjustment arm, the linkage arm, and the suspension arm assembled in a second configuration.

FIG. 9 is a top exploded view showing the extension arm, the height adjustment arm, and the first releasable fastener.

### DETAIL DESCRIPTIONS OF THE INVENTION

All illustrations of the drawings are for the purpose of describing selected versions of the present invention and are not intended to limit the scope of the present invention.

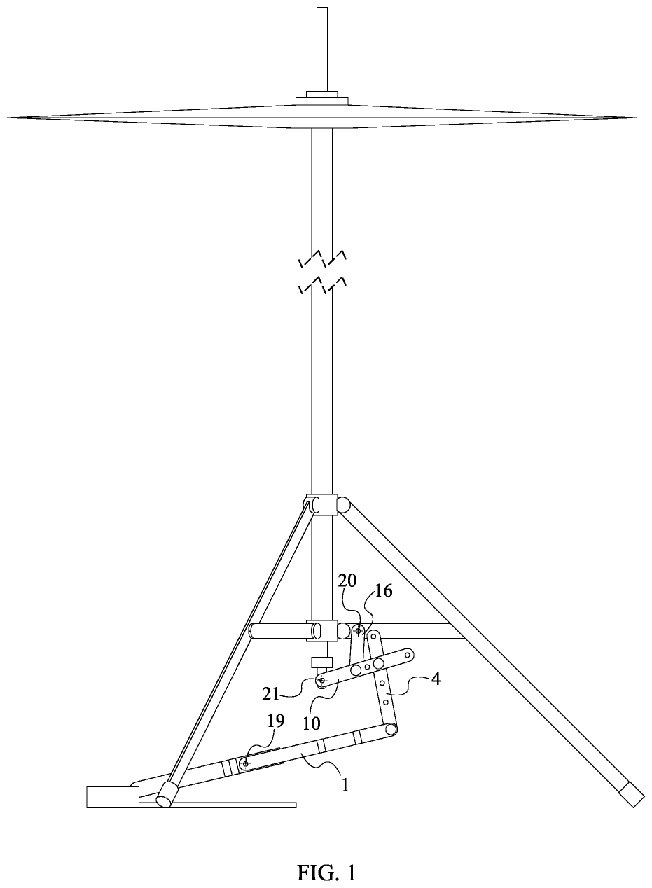

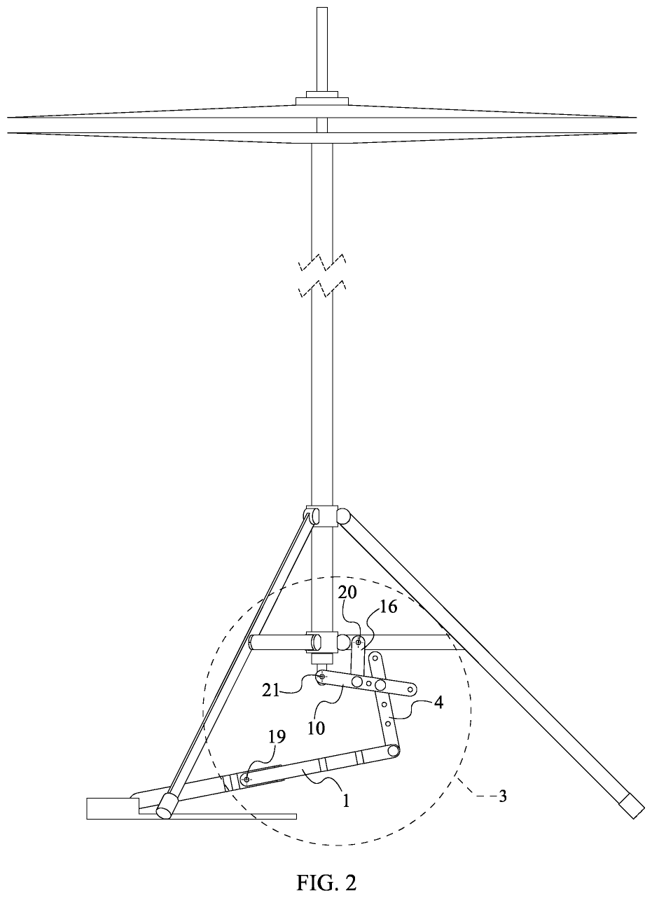

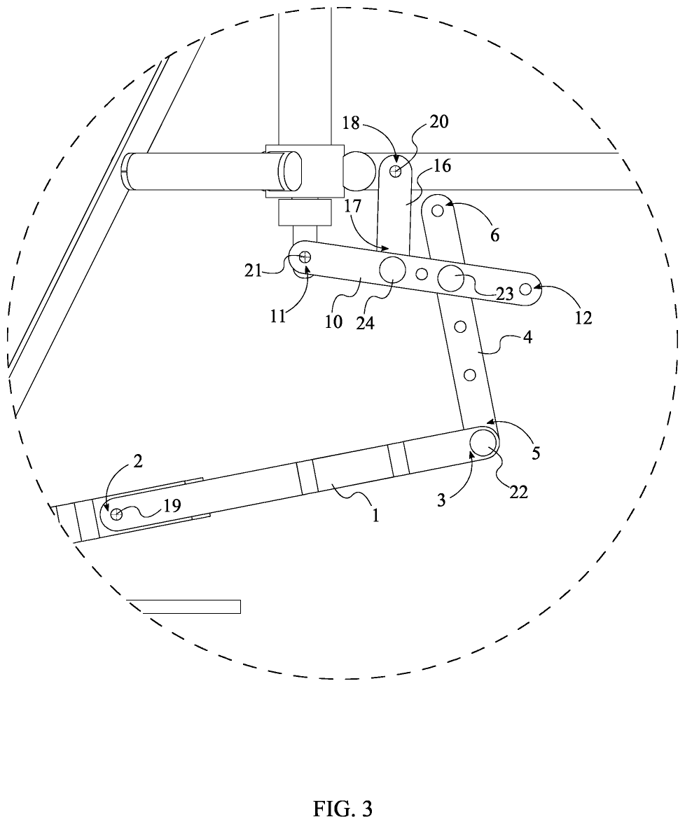

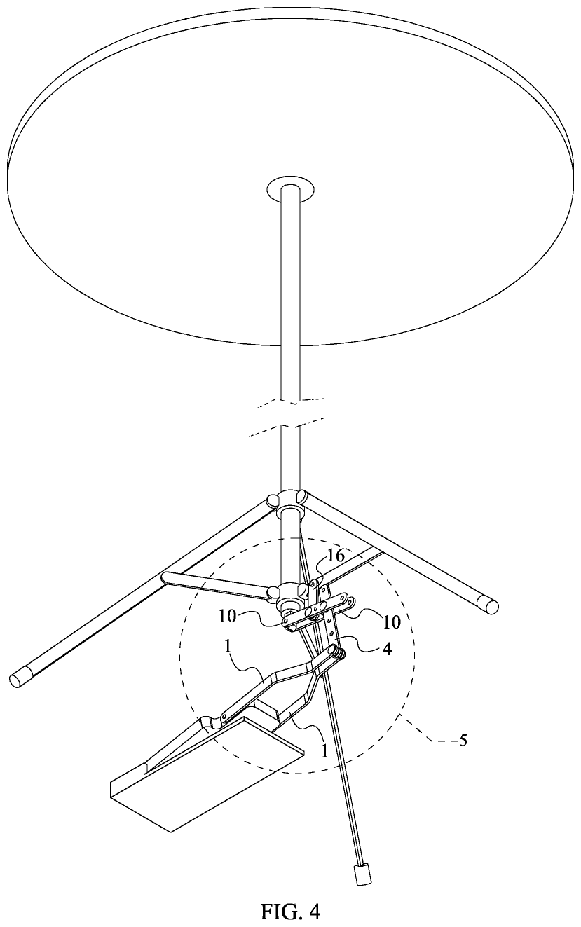

The present invention is a lo-hat drum pedal assembly that enables the user to modify a hi-hat stand to be used in a lo-hat configuration. As can be seen in FIG. 1 through 5, the present invention may comprise an extension arm 1, a height adjustment arm 4, a linkage arm 10, a suspension arm 16, a pedal attachment point 19, a strut attachment point 20, and a connector attachment point 21. The extension arm 1 mechanically couples the stock stand pedal to the height adjustment arm 4. The height adjustment arm 4 mechanically couples the extension arm 1 to the linkage arm 10 in order to transfer the force applied onto the stock stand pedal to the linkage arm 10. The suspension arm 16 enables the linkage arm 10 to be suspended from a stock strut of the stand base so that the linkage arm 10 hangs from the stock strut in a seesaw-like manner. The pedal attachment point 19 corresponds to the location where the extension arm 1 is connected to the stock stand pedal. The strut attachment point 20 corresponds to the location where the suspension arm 16 is connected to the stock strut of the stand base. Finally, the connector attachment point 21 corresponds to the location where the linkage arm 10 is connected to the stock cymbal rod.

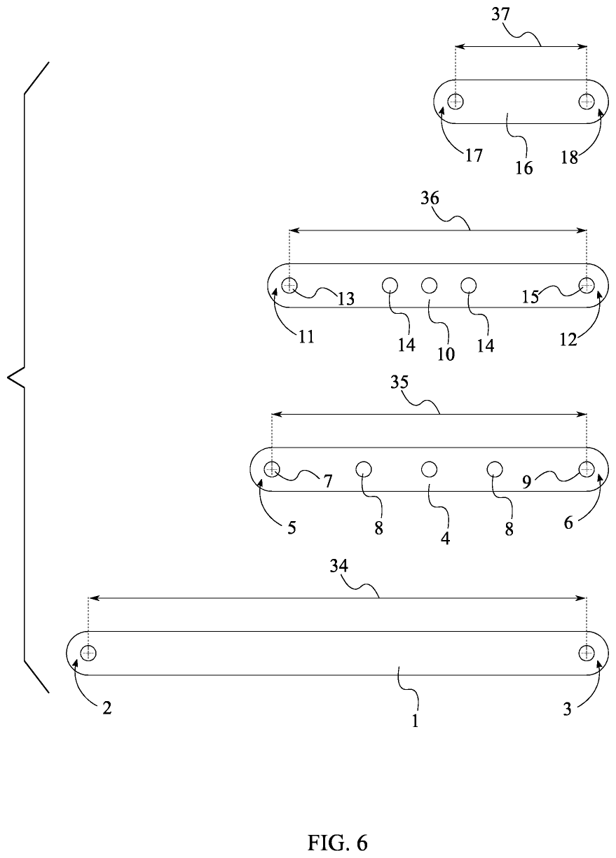

The general configuration of the aforementioned components enables users to play the cymbals in a lo-hat configuration using existing cymbal stands. As can be seen in FIG. 1 through 5, the extension arm 1 is an elongated structure that keeps the stock stand pedal at a comfortable position for the user to step on. The height adjustment arm 4 is also an elongated structure that accommodates different heights for the stock stand pedal. Similarly, both the linkage arm 10 and the suspension arm 16 are elongated structures that are appropriately sized to facilitate the connection of the present invention to the stock cymbal rod. As can be seen in FIG. 6 through 8, the extension arm 1, the height adjustment arm 4, the linkage arm 10, and the suspension arm 16 are preferably thin-flat bars made from chrome-plated steel with an approximate thickness of 0.125 inches (in) and a width of 0.625 in. The terminal ends of each arm are preferably rounded with an approximate radius of 0.375 in. In some embodiments, each of the different arms may include multiple members to increase the structural strength of the present invention. The extension arm 1, the height adjustment arm 4, the linkage arm 10, and the suspension arm 16 may each comprise a pair of elongated members. The pair of elongated members is connected along each other to form a symmetrical arm structure. The extension arm 1 comprises a first extension end 2 and a second extension end 3 corresponding to the terminal ends of the extension arm 1. Like the extension arm 1, the height adjustment arm 4 comprises a first adjustment end 5 and a second adjustment end 6 corresponding to the terminal ends of the height adjustment arm 4. The linkage arm 10 also comprises a first suspension end 17 and a second suspension end 18 corresponding to the terminal ends of the linkage arm 10. Finally, the suspension arm 16 also comprises a first suspension end 17 and a second suspension end 18 corresponding to the terminal ends of the suspension arm 16.

As previously disclosed, the pedal attachment point 19 corresponds to the point where the extension arm 1 is connected to the stock stand pedal. As can be seen in FIG. 1 through 5, the pedal attachment point 19 is integrated into the first extension end 2 so that the stock stand pedal is securely fastened to the extension arm 1 at the first extension end 2. The first extension end 2 can be fixed to the stock stand pedal. In some embodiments, the first extension end 2 can be hingedly connected to the stock stand pedal so that the stock stand pedal can be folded up when not in use. Further, the second extension end 3 is hingedly connected to the first adjustment end 5 so that the extension arm 1 can be aligned with the stock stand pedal's orientation. This allows for the extension arm 1 to pull the height adjustment arm 4 down when the stock stand pedal is stepped on without causing the stock stand pedal nor the stand base to move from their original positions. The height adjustment arm 4 is also hingedly connected to the linkage arm 10, offset from the first linkage end 11, in order to prevent mechanical interference between the extension arm 1 and the linkage arm 10. The hinged connection between the height adjustment arm 4 and the linkage arm 10 also allows for the height adjustment arm 4 to pivot about the linkage arm 10 when the extension arm 1 pulls the height adjustment arm 4 down, which then pulls the linkage arm 10 down. In addition, the first suspension end 17 is hingedly connected to the linkage arm 10, in between the first linkage end 11 and the height adjustment arm 4. This allows for the linkage arm 10 to pivot about the first suspension end 17 in a seesaw-like manner. Moreover, the strut attachment point 20 is integrated into the second suspension end 18 so that the suspension arm 16 hangs from the stock strut of the stand base. The stock strut can correspond to a strut of the stock tripod of the stand base. Finally, the connector attachment point 21 is integrated into the first linkage end 11 so that the linkage arm 10 is connected to the stock cymbal rod. So, as the height adjustment arm 4 pulls the portion of the linkage arm 10 near the second linkage end 12 downwards, the other portion of the linkage arm 10 near the first linkage end 11 is pushed upwards. Thus, the connected stock cymbal rod is raised when the stock stand pedal is pressed down. In some embodiments, the first linkage end 11 may be connected to the stock cymbal rod by a rod connector which enables linkage arm 10 to also rotate about the connector attachment point 21.

To enable the adjustment of the height of the extension arm 1, the height adjustment arm 4 may further comprise a first terminal adjustment hole 7, a plurality of intermediate adjustment holes 8, and a second terminal adjustment hole 9. As can be seen in FIG. 6 through 8, the first terminal adjustment hole 7, the plurality of intermediate adjustment holes 8, and the second terminal adjustment hole 9 enable the user to mechanically couple the second extension end 3 to the height adjustment arm 4 at different positions along the height adjustment arm 4. The first terminal adjustment hole 7, the plurality of intermediate adjustment holes 8, and the second terminal adjustment hole 9 laterally traverse through the height adjustment arm 4. In addition, the first terminal adjustment hole 7, the plurality of intermediate adjustment holes 8, and the second terminal adjustment hole 9 are positioned parallel to each other. Thus, the first terminal adjustment hole 7, the plurality of intermediate adjustment holes 8, and the second terminal adjustment hole 9 do not intersect each other. In addition, the first terminal adjustment hole 7 is positioned at the first adjustment end 5, while the second terminal adjustment hole 9 is positioned at the second adjustment end 6. This allows for the second extension end 3 to be hingedly connected to the first adjustment end 5 using the first terminal adjustment hole 7. Similarly, the height adjustment arm 4 can be hingedly connected to the linkage arm 10 using the second terminal adjustment hole 9. By using the first terminal adjustment hole 7 and the second terminal adjustment hole 9, the extension arm 1 is positioned the furthest from the linkage arm 10. Moreover, the plurality of intermediate adjustment holes 8 is positioned in between the first adjustment end 5 and the second adjustment end 6. The positioning of the plurality of intermediate adjustment holes 8 enables the user to fasten the linkage arm 10 and the extension arm 1 closer to each other along the height adjustment arm 4. Thus, the user can utilize higher pedals or stands with lower bases.

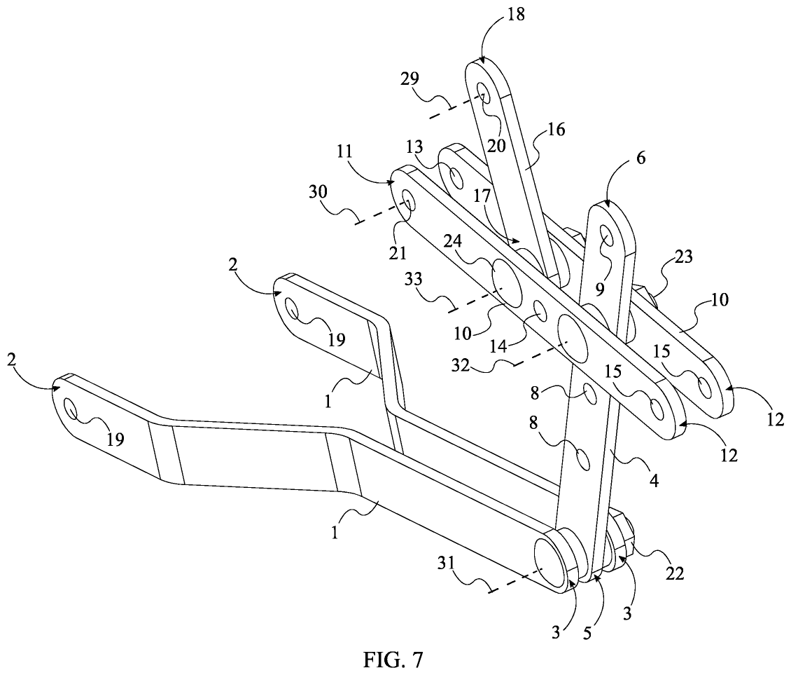

To facilitate the height adjustment of the extension arm 1 along the height adjustment arm 4, the present invention may further comprise a first releasable fastener 22. As can be seen in FIG. 7 through 9, the first releasable fastener 22 enables the quick fastening or unfastening of the second extension end 3 to the height adjustment arm 4. The second extension end 3 is rotatably attached to the first terminal adjustment hole 7 by the first releasable fastener 22. Thus, the height adjustment arm 4 can pivot about the first releasable fastener 22 when the extension arm 1 pulls the height adjustment arm 4 down. Similarly, to facilitate the repositioning of the linkage arm 10 along the height adjustment arm 4, the present invention may further comprise a second releasable fastener 23. The second releasable fastener 23 enables the quick fastening or unfastening of the height adjustment arm 4 to the linkage arm 10. The linkage arm 10 is rotatably attached to the second terminal adjustment hole 9 by the second releasable fastener 23. Thus, the linkage arm 10 can pivot about the second releasable fastener 23 when the height adjustment arm 4 pushes the linkage arm 10 up.

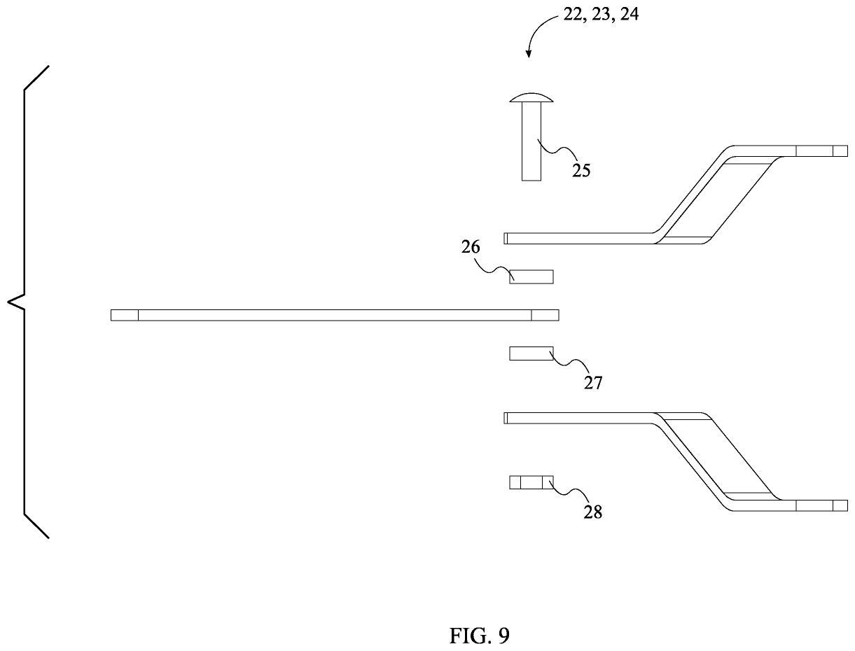

To facilitate the fastening and unfastening of the first releasable fastener 22 and the second releasable fastener 23, each the first releasable fastener 22 and the second releasable fastener 23 is a structure that can be quickly assembly. As can be seen in FIG. 9, the first releasable fastener 22 and the second releasable fastener 23 may each comprise a screw 25, a first felt bushing 26, a second felt bushing 27, and a nut 28. The screw 25 is preferably a Philips screw but can be replaced with other types of screws such as a hand screw. The first felt bushing 26 and the second felt bushing 27 are both designed to prevent vibrations to be transmitted throughout the present invention, thus reducing undesired noise throughout the instrument. The nut 28 secures the assembly to prevent the components from falling off. The first felt bushing 26 is positioned opposite to the second felt bushing 27 about the corresponding arm. For example, when fastening the extension arm 1 to the height adjustment arm 4, the first felt bushing 26 is positioned opposite to the second felt bushing 27 about the height adjustment arm 4. The first felt bushing 26 and the second felt bushing 27 are also aligned with the appropriate hole on the arm. For example, the first felt bushing 26 and the second felt bushing 27 are positioned coincident with the first terminal adjustment hole 7. Then, the first member and the second member of the other arm are positioned opposite to each other about the first arm, the first felt bushing 26, and the second felt bushing 27. For example, the first member of the extension arm 1 is positioned opposite to height adjustment arm 4 about the first felt bushing 26, while the second member of the extension arm 1 is positioned opposite to height adjustment arm 4 about the second felt bushing 27. In addition, the first felt bushing 26 and the second felt bushing 27 are aligned with the appropriate hole on the second arm. For example, the first felt bushing 26 and the second felt bushing 27 are positioned coincident with the second extension end 3 of each member of the extension arm 1. Then, the screw 25 is traversed through the first member of the second arm, the first felt bushing 26, the first arm, and the second felt bushing 27. For example, the screw 25 is traversed through the second extension end 3 of the first member, the first felt bushing 26, first terminal adjustment hole 7, the second extension end 3 of the second member, and through the second felt bushing 27. Finally, the nut 28 is fastened to the screw 25 to secure the assembly while still enabling the rotation of the fastened arms. In other embodiments, the first releasable fastener 22 and the second releasable fastener 23 may be replaced with other quick-to-lock fasteners such as pin-locks.

As previously discussed, the plurality of intermediate adjustment holes 8 enables the extension arm 1 and the linkage arm 10 to be attached to the height adjustment arm 4 at different positions along the height adjustment arm 4. As can be seen in FIG. 6 through 8, the plurality of intermediate adjustment holes 8 is evenly distributed between the first terminal adjustment hole 7 and the second terminal adjustment hole 9. The distribution of the plurality of intermediate adjustment holes 8 enables gradual change of the distance between the extension arm 1 and the linkage arm 10. For example, the user can release the second releasable fastener 23 to reposition the height adjustment arm 4 and match a selected hole of the plurality of intermediate adjustment holes 8 with the linkage arm 10. Then, the user can reattach the second releasable fastener 23 so that the linkage arm 10 is rotatably attached to the selected hole from the plurality of intermediate adjustment holes 8 by the second releasable fastener 23. Thus, the extension arm 1 is positioned closer to the linkage arm 10. Alternatively, other distances between the extension arm 1 and the linkage arm 10 can be achieved using different combinations of holes from the first terminal adjustment hole 7, the plurality of intermediate adjustment holes 8, and/or the second terminal adjustment hole 9.

Like the height adjustment arm 4, the linkage arm 10 may also comprise multiple holes to enable the user to adjust the present invention to fit the desired stand base. As can be seen in FIG. 9, the linkage arm 10 may further comprise a first terminal linkage hole 13, a plurality of intermediate linkage holes 14, and a second terminal linkage hole 15. The first terminal linkage hole 13, the plurality of intermediate linkage holes 14, and the second terminal linkage hole 15 enable the user to mechanically couple the height adjustment arm 4 and the first suspension end 17 to the linkage arm 10 at different positions along the linkage arm 10. The first terminal linkage hole 13, the plurality of intermediate linkage holes 14, and the second terminal linkage hole 15 laterally traverse through the linkage arm 10. In addition, the first terminal linkage hole 13, the plurality of intermediate linkage holes 14, and the second terminal linkage hole 15 are positioned parallel to each other. Thus, the first terminal linkage hole 13, the plurality of intermediate linkage holes 14, and the second terminal linkage hole 15 do not intersect each other. In addition, the first terminal linkage hole 13 is positioned at the first linkage end 11, while the second terminal linkage hole 15 is positioned at the second linkage end 12. This prevents mechanical interference between the height adjustment arm 4 and the stock cymbal rod during their operation. Moreover, the plurality of intermediate linkage holes 14 is positioned in between the first linkage end 11 and the second linkage end 12. The positioning of the plurality of intermediate linkage holes 14 enables the user to position the height adjustment arm 4 closer to the stock cymbal rod.

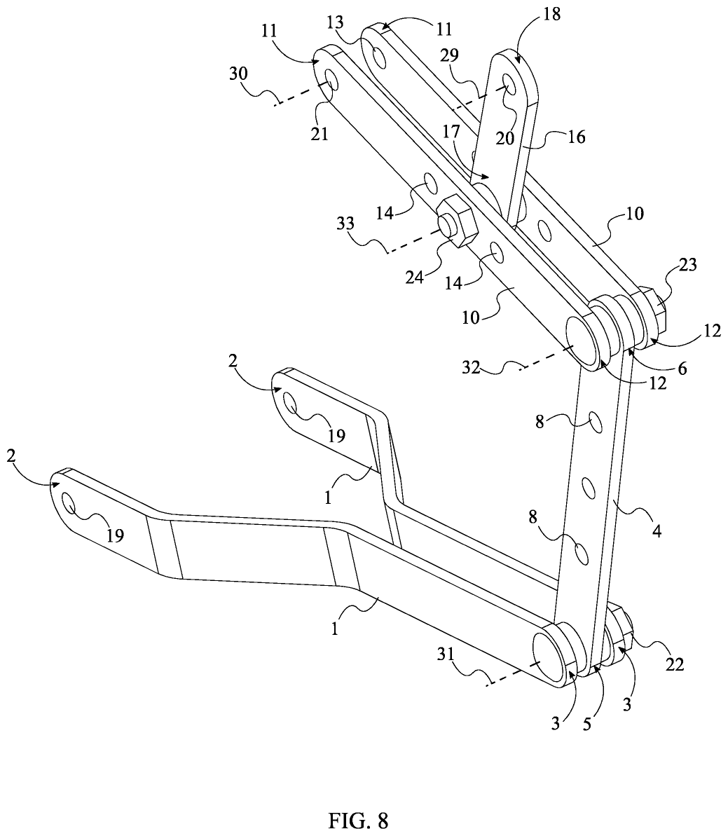

Using the second releasable fastener 23, the user can fasten the height adjustment arm 4 to the linkage arm 10 using the different holes of the plurality of intermediate linkage holes 14 or the second terminal linkage hole 15. As can be seen in FIGS. 7 and 8, the height adjustment arm 4 is rotatably attached to the second terminal linkage hole 15 by the second releasable fastener 23. This positioning corresponds to the furthest distance between the height adjustment arm 4 and the stock cymbal rod. Alternatively, the height adjustment arm 4 can be attached to a selected hole of the plurality of intermediate linkage holes 14. The plurality of intermediate linkage holes 14 is positioned offset from the first terminal linkage hole 13. The plurality of intermediate linkage holes 14 is also positioned offset from the second terminal linkage hole 15. This positioning of the plurality of intermediate linkage holes 14 ensures that the plurality of intermediate linkage holes 14 is centered on the linkage arm 10 so that there is always a large enough moment arm between the height adjustment arm 4 and the stock cymbal rod. Moreover, the height adjustment arm 4 is rotatably attached to a selected hole from the plurality of intermediate linkage holes 14 by the second releasable fastener 23. Thus, the height adjustment arm 4 is positioned closer to the stock cymbal rod.

Furthermore, the suspension arm 16 can be fastened to the linkage arm 10 at different positions using the different holes of the plurality of intermediate linkage holes 14. To do so, the present invention may further comprise a third releasable fastener 24, as can be seen in FIG. 6 through 8. The third releasable fastener 24 may the same releasable fastener as the first releasable fastener 22 and the second releasable fastener 23. The first suspension end 17 is rotatably attached to a selected hole from the plurality of intermediate linkage holes 14 by the third releasable fastener 24. For example, the first suspension end 17 can be attached to the center hole from the plurality of intermediate linkage holes 14 when the height adjustment arm 4 is attached to the second terminal linkage hole 15 by the second releasable fastener 23. Alternatively, the first suspension end 17 can be attached to a hole from the plurality of intermediate linkage holes 14 adjacent to the first linkage end 11 when the height adjustment arm 4 is attached to another hole of the plurality of intermediate linkage holes 14 adjacent to the second linkage end 12. Thus, the linkage arm 10 is able to pivot about the third releasable fastener 24 at different positions corresponding to the different holes of the plurality of intermediate linkage holes 14.

To maximize the efficiency of the present invention, specific length ratios may be utilized to ensure that the correct force is transmitted from the stock pedal, through the present invention, and to the stock cymbal rod to raise or lower the stock top cymbal as the user desires, as can be seen in FIG. 6. A ratio between a first functional length 34 of the extension arm 1 and a second functional length 35 of the height adjustment arm 4 is approximately 0.632 so that the extension arm 1 is longer than the height adjustment arm 4. A ratio between the first functional length 34 of the extension arm 1 and a third functional length 36 of the linkage arm 10 is approximately 0.596 so that the extension arm 1 is longer than the linkage arm 10, and that the linkage arm 10 is shorter than the height adjustment arm 4. Further, a ratio between the first functional length 34 of the extension arm 1 and a fourth functional length 37 of the suspension arm 16 is approximately 0.263 so that the extension arm 1 is longer than twice the length of the suspension arm 16, making the suspension arm 16 the shortest of the different arms. For example, the extension arm 1 preferably has a functional length of 7.125 in, the height adjustment arm 4 has a functional length of 4.5 in, the linkage arm 10 has a functional length of 4.25 in, and the suspension arm 16 has a functional length of 1.875 in. In other embodiments, the length ratios may be modified to accommodate nontraditional hi-hat stands.

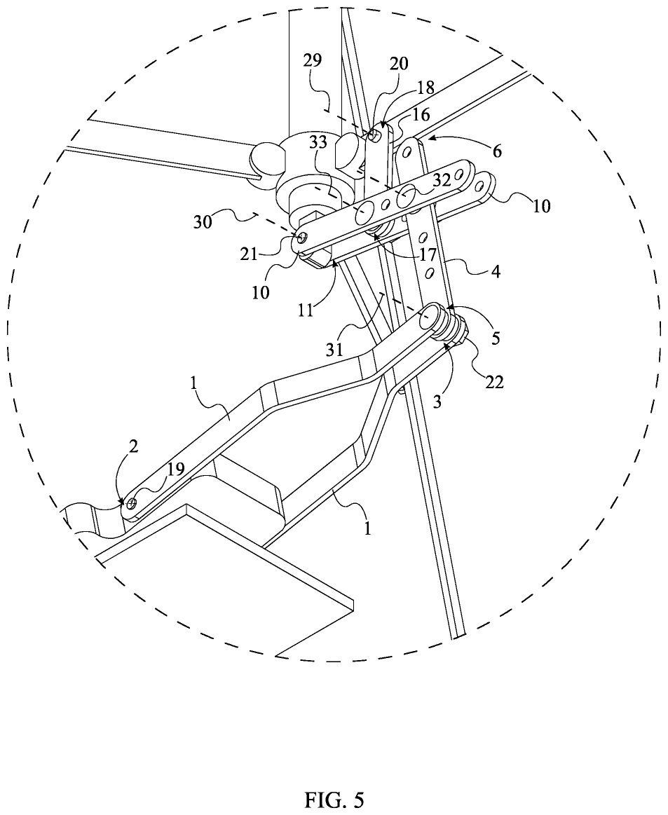

Furthermore, to prevent undesired twisting of the present invention, all rotations of the different components are aligned in a desired orientation. As can be seen in FIGS. 5, 7, and 8, the strut attachment point 20 may comprise a first rotation axis 29. The connector attachment point 21 also comprises a second rotation axis 30. In addition, the second extension end 3 is hingedly connected to the first adjustment end 5 about a third rotation axis 31. The height adjustment arm 4 is hingedly connected to the linkage arm 10 about a fourth rotation axis 32. Moreover, the first suspension end 17 is hingedly connected to the linkage arm 10 about a fifth rotation axis 33. The first rotation axis 29, the second rotation axis 30, the third rotation axis 31, the fourth rotation axis 32, and the fifth rotation axis 33 are positioned parallel to each other. Thus, all rotations of the different components are angular motions that do not cause twisting of the present invention. For example, when the extension arm 1 pulls the height adjustment arm 4 down as the user steps on the pedal, the extension arm 1 will only pull the height adjustment arm 4 straight downwards and not in angle.

Although the invention has been explained in relation to its preferred embodiment, it is to be understood that many other possible modifications and variations can be made without departing from the spirit and scope of the invention.

What is claimed is:

1. A lo-hat drum pedal assembly comprising:
an extension arm;
a height adjustment arm;
a linkage arm;
a suspension arm;
a pedal attachment point;
a strut attachment point;
a connector attachment point;
the extension arm comprising a first extension end and a second extension end;
the height adjustment arm comprising a first adjustment end and a second adjustment end;
the linkage arm comprising a first linkage end and a second linkage end;
the suspension arm comprising a first suspension end and a second suspension end;
the pedal attachment point being integrated into the first extension end;
the second extension end being hingedly connected to the first adjustment end;
the height adjustment arm being hingedly connected to the linkage arm, offset from the first linkage end;
the first suspension end being hingedly connected to the linkage arm, in between the first linkage end and the height adjustment arm;
the strut attachment point being integrated into the second suspension end; and,
the connector attachment point being integrated into the first linkage end.

2. The lo-hat drum pedal assembly as claimed in claim 1 comprising:
the height adjustment arm further comprising a first terminal adjustment hole, a plurality of intermediate adjustment holes, and a second terminal adjustment hole;
the first terminal adjustment hole, each of the plurality of intermediate adjustment holes, and the second terminal adjustment hole laterally traversing through the height adjustment arm;
the first terminal adjustment hole, each of the plurality of intermediate adjustment holes, and the second terminal adjustment hole being positioned parallel to each other;
the first terminal adjustment hole being positioned at the first adjustment end;
the second terminal adjustment hole being positioned at the second adjustment end; and,
the plurality of intermediate adjustment holes being positioned in between the first adjustment end and the second adjustment end.

3. The lo-hat drum pedal assembly as claimed in claim 2 comprising:
a first releasable fastener; and,
the second extension end being rotatably attached to the first terminal adjustment hole by the first releasable fastener.

4. The lo-hat drum pedal assembly as claimed in claim 2 comprising:
a second releasable fastener; and,
the linkage arm being rotatably attached to the second terminal adjustment hole by the second releasable fastener.

5. The lo-hat drum pedal assembly as claimed in claim 2 comprising:
a second releasable fastener;
the plurality of intermediate adjustment holes being evenly distributed between the first terminal adjustment hole and the second terminal adjustment hole; and,
the linkage arm being rotatably attached to a selected hole from the plurality of intermediate adjustment holes by the second releasable fastener.

6. The lo-hat drum pedal assembly as claimed in claim 1 comprising:
the linkage arm further comprising a first terminal linkage hole, a plurality of intermediate linkage holes, and a second terminal linkage hole;
the first terminal linkage hole, each of the plurality of intermediate linkage holes, and the second terminal linkage hole laterally traversing through the linkage arm;
the first terminal linkage hole, each of the plurality of intermediate linkage holes, and the second terminal linkage hole being positioned parallel to each other;
the first terminal linkage hole being positioned at the first linkage end;
the second terminal linkage hole being positioned at the second linkage end; and,
the plurality of intermediate linkage holes being positioned in between the first linkage end and the second linkage end.

7. The lo-hat drum pedal assembly as claimed in claim 6 comprising:
a second releasable fastener; and,
the height adjustment arm being rotatably attached to the second terminal linkage hole by the second releasable fastener.

8. The lo-hat drum pedal assembly as claimed in claim 6 comprising:
a second releasable fastener;
the plurality of intermediate linkage holes being positioned offset from the first terminal linkage hole;
the plurality of intermediate linkage holes being positioned offset from the second terminal linkage hole; and,
the height adjustment arm being rotatably attached to a selected hole from the plurality of intermediate linkage holes by the second releasable fastener.

9. The lo-hat drum pedal assembly as claimed in claim 6 comprising:
a third releasable fastener;
the plurality of intermediate linkage holes being positioned offset from the first terminal linkage hole;
the plurality of intermediate linkage holes being positioned offset from the second terminal linkage hole; and,
the first suspension end being rotatably attached to a selected hole from the plurality of intermediate linkage holes by the third releasable fastener.

10. The lo-hat drum pedal assembly as claimed in claim 1 comprising:
a ratio between a first functional length of the extension arm and a second functional length of the height adjustment arm being approximately 0.632;
a ratio between the first functional length of the extension arm and a third functional length of the linkage arm being approximately 0.596; and,
a ratio between the first functional length of the extension arm and a fourth functional length of the suspension arm being approximately 0.263.

11. The lo-hat drum pedal assembly as claimed in claim 1 comprising:
the strut attachment point comprising a first rotation axis;
the connector attachment point comprising a second rotation axis;
the second extension end being hingedly connected to the first adjustment end about a third rotation axis;
the height adjustment arm being hingedly connected to the linkage arm about a fourth rotation axis;
the first suspension end being hingedly connected to the linkage arm about a fifth rotation axis; and,
the first rotation axis, the second rotation axis, the third rotation axis, the fourth rotation axis, and the fifth rotation axis being positioned parallel to each other.

12. A lo-hat drum pedal assembly comprising:
an extension arm;
a height adjustment arm;
a linkage arm;
a suspension arm;
a pedal attachment point;
a strut attachment point;
a connector attachment point;
the extension arm comprising a first extension end and a second extension end;
the height adjustment arm comprising a first adjustment end and a second adjustment end;
the linkage arm comprising a first linkage end and a second linkage end;
the suspension arm comprising a first suspension end and a second suspension end;
the strut attachment point comprising a first rotation axis;
the connector attachment point comprising a second rotation axis;
the pedal attachment point being integrated into the first extension end;
the second extension end being hingedly connected to the first adjustment end about a third rotation axis;
the height adjustment arm being hingedly connected to the linkage arm about a fourth rotation axis, offset from the first linkage end;
the first suspension end being hingedly connected to the linkage arm about a fifth rotation axis, in between the first linkage end and the height adjustment arm;
the strut attachment point being integrated into the second suspension end;
the connector attachment point being integrated into the first linkage end; and,
the first rotation axis, the second rotation axis, the third rotation axis, the fourth rotation axis, and the fifth rotation axis being positioned parallel to each other.

13. The lo-hat drum pedal assembly as claimed in claim 12 comprising:
a first releasable fastener;
the height adjustment arm further comprising a first terminal adjustment hole, a plurality of intermediate adjustment holes, and a second terminal adjustment hole;
the first terminal adjustment hole, each of the plurality of intermediate adjustment holes, and the second terminal adjustment hole laterally traversing through the height adjustment arm;
the first terminal adjustment hole, each of the plurality of intermediate adjustment holes, and the second terminal adjustment hole being positioned parallel to each other;
the first terminal adjustment hole being positioned at the first adjustment end;
the second terminal adjustment hole being positioned at the second adjustment end;
the plurality of intermediate adjustment holes being positioned in between the first adjustment end and the second adjustment end; and,
the second extension end being rotatably attached to the first terminal adjustment hole by the first releasable fastener.

14. The lo-hat drum pedal assembly as claimed in claim 13 comprising:
a second releasable fastener; and,
the linkage arm being rotatably attached to the second terminal adjustment hole by the second releasable fastener.

15. The lo-hat drum pedal assembly as claimed in claim 13 comprising:
a second releasable fastener;
the plurality of intermediate adjustment holes being evenly distributed between the first terminal adjustment hole and the second terminal adjustment hole; and,
the linkage arm being rotatably attached to a selected hole from the plurality of intermediate adjustment holes by the second releasable fastener.

16. The lo-hat drum pedal assembly as claimed in claim 12 comprising:
a third releasable fastener;
the linkage arm further comprising a first terminal linkage hole, a plurality of intermediate linkage holes, and a second terminal linkage hole;
the first terminal linkage hole, each of the plurality of intermediate linkage holes, and the second terminal linkage hole laterally traversing through the linkage arm;
the first terminal linkage hole, each of the plurality of intermediate linkage holes, and the second terminal linkage hole being positioned parallel to each other;
the first terminal linkage hole being positioned at the first linkage end;
the second terminal linkage hole being positioned at the second linkage end;
the plurality of intermediate linkage holes being positioned in between the first linkage end and the second linkage end;
the plurality of intermediate linkage holes being positioned offset from the first terminal linkage hole;
the plurality of intermediate linkage holes being positioned offset from the second terminal linkage hole; and,
the first suspension end being rotatably attached to a selected hole from the plurality of intermediate linkage holes by the third releasable fastener.

17. The lo-hat drum pedal assembly as claimed in claim 16 comprising:
a second releasable fastener; and,
the height adjustment arm being rotatably attached to the second terminal linkage hole by the second releasable fastener.

18. The lo-hat drum pedal assembly as claimed in claim 16 comprising:
a second releasable fastener;
the plurality of intermediate linkage holes being positioned offset from the first terminal linkage hole;
the plurality of intermediate linkage holes being positioned offset from the second terminal linkage hole; and,
the height adjustment arm being rotatably attached to a selected hole from the plurality of intermediate linkage holes by the second releasable fastener.

19. The lo-hat drum pedal assembly as claimed in claim 12 comprising:
a ratio between a first functional length of the extension arm and a second functional length of the height adjustment arm being approximately 0.632;
a ratio between the first functional length of the extension arm and a third functional length of the linkage arm being approximately 0.596; and,
a ratio between the first functional length of the extension arm and a fourth functional length of the suspension arm being approximately 0.263.
